(19) United States
(12) Patent Application Publication
(10) Pub. No.: US 2019/0230323 A1
(43) Pub. Date: Jul. 25, 2019

(54) VEHICLE VISION SYSTEM WITH WIRELESS CAMERA PAIRING

(71) Applicant: Magna Electronics Inc., Auburn Hills, MI (US)

(72) Inventors: Krishna Koravadi, Rochester Hills, MI (US); Yuesheng Lu, Farmington Hills, MI (US); Vivek Vaid, South Lyon, MI (US)

(21) Appl. No.: 16/250,480

(22) Filed: Jan. 17, 2019

Related U.S. Application Data
(60) Provisional application No. 62/619,953, filed on Jan. 22, 2018.

(51) Int. Cl. H04N 7/18; B60R 11/04; B60R 1/12; H04N 5/232; H04W 4/80; B60R 1/00

(52) U.S. Cl. CPC H04N 7/181; B60R 11/04; B60R 1/12; H04N 5/23206; B60R 2300/105; B60R 1/001; B60R 2001/1253; B60R 2300/802; B60R 2300/8066; H04W 4/80

(57) ABSTRACT

A vehicular vision system and method includes a camera disposed at a vehicle and having a field of view interior or exterior of the vehicle. The camera is operable to wirelessly transmit image data captured by the camera. A display is disposed in the vehicle and is operable to display video images derived from image data captured by the camera and wirelessly transmitted by the camera. When operating in a setup mode, the camera wirelessly communicates with a portable device that configures the camera (i) for connection to a vehicular Wi-Fi hotspot of the vehicle and (ii) for operation of the camera with a control of the vehicle, whereby the display displays video images derived from the captured image data received at the control.

### CROSS REFERENCE TO RELATED APPLICATION

The present application claims the filing benefits of U.S. provisional application Ser. No. 62/619,953, filed Jan. 22, 2018, which is hereby incorporated herein by reference in its entirety.

### FIELD OF THE INVENTION

The present invention relates generally to a vehicle vision system for a vehicle and, more particularly, to a vehicle vision system that utilizes one or more wireless cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

The present invention provides a driver assistance system or vision system or imaging system for a vehicle that utilizes one or more cameras to capture image data representative of images exterior of the vehicle, and provides a method and apparatus to pair a Wi-Fi camera to a Wi-Fi hot spot. In accordance with an aspect of the invention, the Wi-Fi camera acts as a temporary access point to allow a smart phone to connect to the Wi-Fi camera and configure the permanent Wi-Fi network. In accordance with another aspect of the invention, the Wi-Fi camera may have a BLUETOOTH® interface or near field interface to configure the Wi-Fi camera.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras in accordance with the present invention;

FIG. 2 is a block diagram of a system using a mobile device to set up a wireless camera of the vehicle with a vehicle hot spot;

FIG. 3 is a block diagram of another system using a vehicle display to set up the wireless camera with the vehicle hot spot; and

FIG. 4 is a block diagram of another system using a mobile device and a BLUETOOTH® communication link to set up a wireless camera of the vehicle with a vehicle hot spot.

### LEGEND

100—Wireless camera with Wi-Fi interface

101—mobile device

102—Wi-Fi antenna of wireless camera

104—Wi-Fi interface mobile device side

105a, b—BLUETOOTH®/near field communication wireless interface

106—Wi-Fi antenna of the dash board display module

107—BLUETOOTH®/near field communication wireless interface

108—Dash board display to view the video streamed via antenna 102

110—Acceleration sensor

112—Button to initiate the wireless camera setup process

114—Wireless camera configuration interface

### DESCRIPTION OF THE PREFERRED EMBODIMENTS

A vehicle vision system and/or driver assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide display, such as a rearview display or a top down or bird's eye or surround view display or the like.

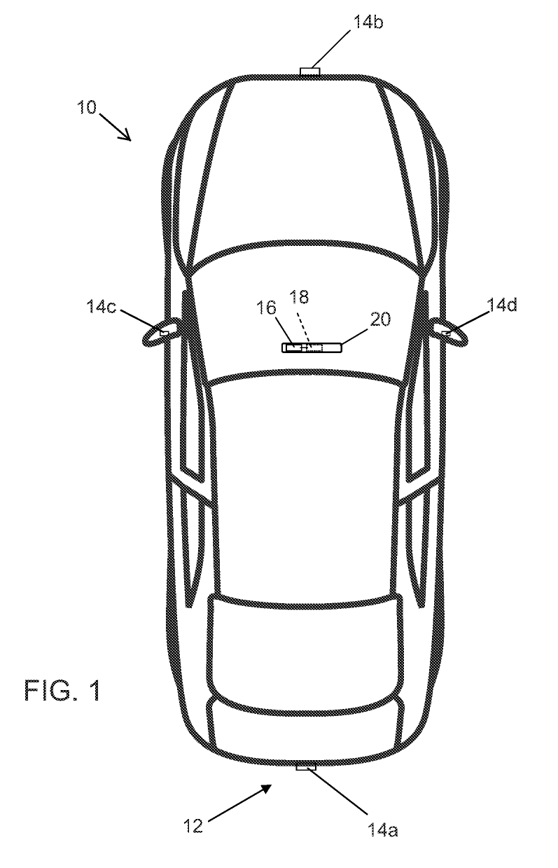

Referring now to the drawings and the illustrative embodiments depicted therein, a vehicle 10 includes an imaging system or vision system 12 that includes at least one exterior viewing imaging sensor or camera, such as a rearward viewing imaging sensor or camera 14a (and the system may optionally include multiple exterior viewing imaging sensors or cameras, such as a forward viewing camera 14b at the front (or at the windshield) of the vehicle, and a sideward/rearward viewing camera 14c , 14d at respective sides of the vehicle), which captures images exterior of the vehicle, with the camera having a lens for focusing images at or onto an imaging array or imaging plane or imager of the camera (FIG. 1). Optionally, a forward viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). The vision system 12 includes a control or electronic control unit (ECU) or processor 18 that is operable to process image data captured by the camera or cameras and may detect objects or the like and/or provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle. The camera or cameras may comprise wireless cameras that may wirelessly communicate image data to a processor or a display at the vehicle and may wirelessly communicate with a device and/or display.

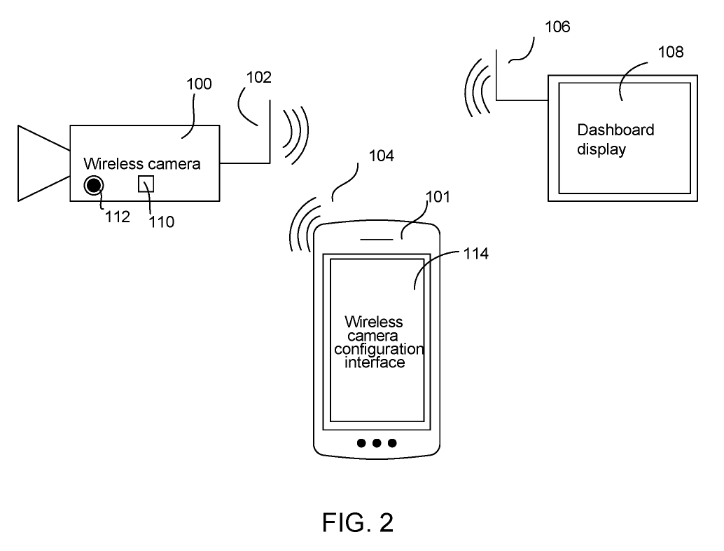

FIG. 2 illustrates a Wi-Fi configuration setup for a wireless camera 100 at a vehicle. The wireless camera 100 is equipped with a button 112 to initiate a Wi-Fi configuration process. Once the wireless camera 100 is in the Wi-Fi setup mode (such as responsive to a user actuation of the button 112 or other user input), the wireless camera acts as a temporary hotspot and the user connects a mobile device 101 to the temporary hotspot. Connecting to the temporary hotspot (of the camera 100) may include authenticating the user and/or the mobile device 101. After connecting, the user may configure the wireless camera 100 to connect to a hotspot of the vehicle utilizing a configuration interface 114, such as a web interface. Once the wireless camera is configured to the vehicle hotspot with any necessary information or authentication (e.g., IDs, passwords, etc.), the wireless camera will come out of the temporary hotspot mode and connect to the hotspot of the vehicle (such as a dashboard display 108 hotspot or the like). The display and/or hotspot may use antenna 106 to communicate with the camera 100. The camera and system thus are operable in a setup mode, in which the system allows for a user to connect and authenticate a user's mobile device with the camera and to configure the camera for wirelessly communicating with a control of the vehicle, and an operating mode, in which the camera wirelessly transmits image data that is received at the control, whereby the display device displays video images derived from the wirelessly transmitted captured image data.

Optionally, the wireless camera is equipped with an acceleration sensor 110 that detects the certain motion pattern to activate the Wi-Fi configuration setup. In such an application, the user need not actuate a user input, but can maneuver the vehicle or otherwise cause or generate the particular motion pattern, whereby the camera enters the Wi-Fi configuration set up and the user can use the mobile device (such as a smart phone or other mobile electronic device) to configure the wireless camera to connect to a hotspot of the vehicle (such as a dashboard display hotspot or the like).

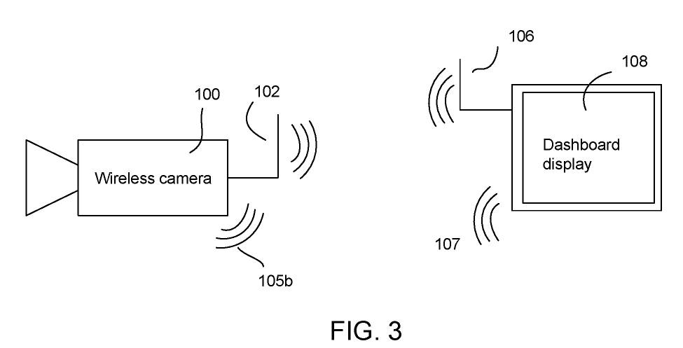

FIG. 3 illustrates an alternative Wi-Fi configuration setup for the wireless camera 100. The user utilizes the dash board display 108 to initiate the secure connection with the wireless camera 100 utilizing a BLUETOOTH® or near field communication link 105b, 107. Once the secure connection is established, the user enters the authentication details for the dash board display hotspot 108.

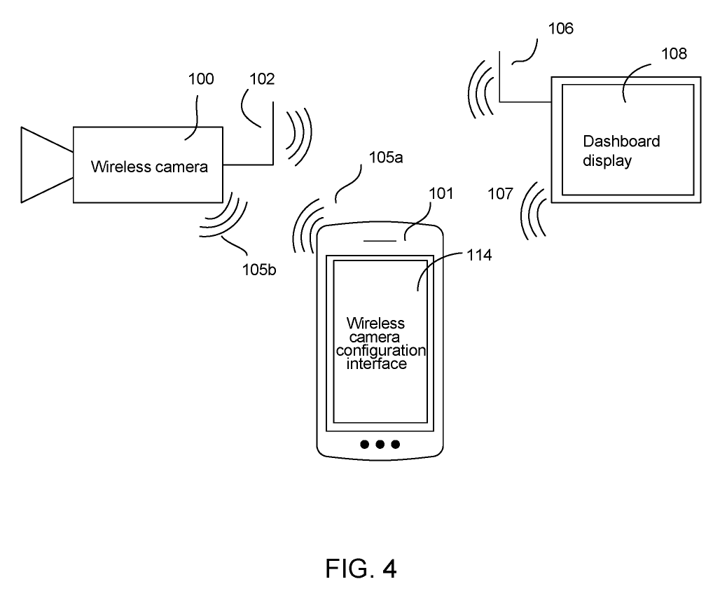

FIG. 4 illustrates an alternative Wi-Fi configuration setup for the wireless camera 100. The user utilizes the mobile device 101 to initiate the secure connection with the wireless camera 100 utilizing a BLUETOOTH® or near field communication link 105a, b. Once the secure connection is established, the user enters the authentication details for the dash board display hotspot 108, via a BLUETOOTH® or near field communication link 105a, 107.

Thus, the present invention provides a system for connecting a wireless camera to a vehicle hotspot and configuring the camera to work with a vehicle control and display and to communicate wirelessly with the vehicle control and/or display. The camera can temporarily act as a hotspot during a setup process, and then, after configuration, can link to the vehicle hotspot for operation. The system thus allows a user to readily connect and configure a wireless camera (such as an aftermarket wireless camera) for operation with a vehicle control or display (such as a dashboard or console display or mirror display or the like) and so that the camera is at least temporarily linked to the vehicle hotspot, when installing and configuring the wireless camera at the vehicle.

The vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties.

Optionally, the display for displaying images captured by one or more of the imaging sensors for viewing by the driver of the vehicle while the driver is normally operating the vehicle, may, for example, the vision system may include a video display device, such as by utilizing aspects of the video display systems described in U.S. Pat. Nos. 5,530,240; 6,329,925; 7,855,755; 7,626,749; 7,581,859; 7,446,650; 7,338,177; 7,274,501; 7,255,451; 7,195,381; 7,184,190; 5,668,663; 5,724,187; 6,690,268; 7,370,983; 7,329,013; 7,308,341; 7,289,037; 7,249,860; 7,004,593; 4,546,551; 5,699,044; 4,953,305; 5,576,687; 5,632,092; 5,708,410; 5,737,226; 5,802,727; 5,878,370; 6,087,953; 6,173,501; 6,222,460; 6,513,252 and/or 6,642,851, and/or U.S. Publication Nos. US-2014-0022390; US-2012-0162427; US-2006-0050018 and/or US-2006-0061008, which are all hereby incorporated herein by reference in their entireties. Optionally, the vision system (utilizing the forward viewing camera and a rearward viewing camera and other cameras disposed at the vehicle with exterior fields of view) may be part of or may provide a display of a top-down view or bird's-eye view system of the vehicle or a surround view at the vehicle, such as by utilizing aspects of the vision systems described in International Publication Nos. WO 2010/099416; WO 2011/028686; WO 2012/075250; WO 2013/019795; WO 2012/075250; WO 2012/145822; WO 2013/081985; WO 2013/086249 and/or WO 2013/109869, and/or U.S. Publication No. US-2012-0162427, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular vision system, said vehicular vision system comprising:
a camera configured to be disposed at a vehicle so as to have a field of view interior or exterior of the vehicle, wherein said camera is operable to capture image data;
wherein said camera is operable to wirelessly transmit captured image data;
a display device disposed in the vehicle, said display device comprising a video display screen;
wherein, with said camera disposed at the vehicle, and when operating in a setup mode, said camera wirelessly communicates with a portable device brought into the vehicle by a user of the portable device;
wherein, responsive to the wireless communication with said camera, the portable device wirelessly configures said camera for connection to a vehicular Wi-Fi hotspot of the vehicle;
a control disposed in the vehicle, wherein said control is operable to wirelessly receive captured image data wirelessly transmitted by said camera;
wherein, after the setup mode is completed, and with said camera configured for connection to the vehicular Wi-Fi hotspot of the vehicle, and with the configured camera capturing image data and wirelessly transmitting captured image data, said control receives the captured image data wirelessly transmitted by the configured camera; and
wherein said video display screen, responsive to said control receiving the captured image data wirelessly transmitted by the configured camera, displays video images derived from the received wirelessly transmitted captured image data.

2. The vehicular vision system of claim 1, wherein said camera operates in the setup mode responsive to actuation of a user input.

3. The vehicular vision system of claim 2, wherein the user input is at said camera.

4. The vehicular vision system of claim 2, wherein the user input comprises a sensor of said camera, and wherein the user input is actuated via maneuvering the vehicle in a predetermined manner.

5. The vehicular vision system of claim 1, wherein, when operating in the setup mode, said camera operates as a temporary Wi-Fi hotspot and the portable device utilizes said camera's temporary Wi-Fi hotspot to configure said camera.

6. The vehicular vision system of claim 1, wherein, when operating in the setup mode, said camera connects to the vehicular Wi-Fi hotspot of the vehicle and the portable device utilizes the vehicular Wi-Fi hotspot of the vehicle to configure said camera.

7. The vehicular vision system of claim 1, wherein said camera wirelessly transmits image data via a first wireless communication link, and wherein said camera wirelessly communicates with the portable device via a second wireless communication link.

8. The vehicular vision system of claim 7, wherein the second wireless communication link comprises a near field communication protocol.

9. The vehicular vision system of claim 8, wherein the portable device comprises a smart phone of the user.

10. A method for installation and use of a wireless camera at a vehicle, said method comprising:
providing a camera at a vehicle so as to have a field of view interior or exterior of the vehicle, wherein the camera is operable to capture image data, and wherein the camera is operable to wirelessly transmit captured image data;
providing a control in the vehicle;
providing a display device in the vehicle, the display device comprising a video display screen;
actuating a setup mode of the camera;
when operating in a setup mode, wirelessly communicating, via the camera, with a portable device brought into the vehicle by a user of the portable device;
wherein wirelessly communicating, via the camera, with the portable device comprises configuring the camera for connection to a vehicular Wi-Fi hotspot of the vehicle;
after the setup mode is completed, and with the camera configured for connection to the vehicular Wi-Fi hotspot of the vehicle, capturing image data via the configured camera and wirelessly transmitting captured image data via the configured camera;
receiving, at the control, captured image data wirelessly transmitted by the configured camera; and
responsive to the control receiving captured image data wirelessly transmitted by the configured camera, displaying, at the video display screen, video images derived from the received wirelessly transmitted captured image data.

11. The method of claim 10, wherein actuating the setup mode of the camera comprises actuating the setup mode of the camera by actuating a user input.

12. The method of claim 11, wherein the user input is at said camera.

13. The method of claim 10, wherein operating in the setup mode comprises operating the camera as a temporary Wi-Fi hotspot, whereby the portable device utilizes the camera's temporary Wi-Fi hotspot to configure the camera.

14. The method of claim 10, wherein operating in the setup mode comprises wirelessly connecting the camera to the vehicular Wi-Fi hotspot of the vehicle, whereby the portable device utilizes the vehicular Wi-Fi hotspot of the vehicle to configure the camera.

15. The method of claim 10, wherein wirelessly transmitting image data via the camera comprises wirelessly transmitting image data via a first wireless communication link, and wherein wirelessly communicating with the portable device comprises wirelessly communicating with the portable device via a second wireless communication link.

16. The method of claim 15, wherein the second wireless communication link comprises a near field communication protocol.

17. The method of claim 16, wherein the portable device comprises a smart phone of the user.

18. A method for installation and use of a wireless camera at a vehicle, said method comprising:
providing a camera at a vehicle so as to have a field of view interior or exterior of the vehicle, wherein the camera is operable to capture image data, and wherein the camera is operable to wirelessly transmit captured image data;
providing a control in the vehicle;
providing a display device in the vehicle, the display device comprising a video display screen;
actuating a setup mode of the camera by wirelessly communicating, via a portable device brought into the vehicle by a user of the portable device, with the camera;
when operating in a setup mode, wirelessly communicating, via the portable device, with the camera to establish wireless communication between the camera and a vehicular Wi-Fi hotspot of the vehicle;
wherein the vehicular Wi-Fi hotspot of the vehicle is used by the portable device to configure the camera for wirelessly communicating with the control;
after the setup mode is completed, with the camera configured for connection to the vehicular Wi-Fi hotspot of the vehicle so that wireless communication is established between the configured camera and the control, capturing image data via the configured camera and wirelessly transmitting captured image data via the configured camera;
receiving, at the control, captured image data wirelessly transmitted by the configured camera; and
responsive to the control receiving captured image data wirelessly transmitted by the configured camera, displaying, at the video display screen, video images derived from the received wirelessly transmitted captured image data.

19. The method of claim 18, wherein actuating the setup mode of the camera comprises actuating the setup mode of the camera by actuating a user input.

20. The method of claim 18, wherein wirelessly transmitting image data via the camera comprises wirelessly transmitting image data via a first wireless communication link, and wherein wirelessly communicating via the camera with the portable device comprises wirelessly communicating with the portable device via a second wireless communication link, and wherein the second wireless communication link comprises a near field communication protocol.
